(19) United States
(12) Patent Application Publication
(10) Pub. No.: US 2026/0105656 A1
(43) Pub. Date: Apr. 16, 2026

(54) PRESENTATION GENERATION USING KNOWLEDGE GRAPH-INFORMED CONTENT FITTING

(71) Applicant: ADOBE INC., SAN JOSE, CA (US)

(72) Inventors: Paul Sumedrea, Brasov (RO); Alexandru-Gabriel Ilie, Ploiesti (RO); Teodor-Constantin Popescu, Berbesti (RO); Ionut Mironicä, Bucharest District 3 (RO)

(21) Appl. No.: 18/916,027

(22) Filed: Oct. 15, 2024

(51) Int. Cl. G06T 11/60; G06T 7/10; G06V 10/764

(52) U.S. Cl. CPC G06T 11/60; G06T 7/10; G06V 10/764

(57) ABSTRACT

A method, apparatus, non-transitory computer readable medium, and system for generating presentations includes obtaining an input prompt describing a topic and generating, using a text generation model, a presentation outline based on the input prompt. A presentation structure is then generated based on the presentation outline, where the presentation structure includes a structured attribute indicating a slide layout element. A presentation on the topic is generated based on the presentation structure, wherein the presentation comprises a slide including the slide layout element.

### BACKGROUND

The following relates generally to data generation, and more specifically to generation of slide presentations. Data generation involves the creation of new data based on existing information or predefined rules. Traditional rule-based techniques, such as interpolation and probabilistic models, have long been used to generate data in fields like mathematics, physics, and finance. These methods rely on established patterns and distributions to produce new data points within a known range. More recently, machine learning (ML) models have been employed to generate data across various domains such as sequence data, text, audio, and image data.

Slide presentations are a common format for conveying information in a structured visual manner. Slide presentations are used to communicate ideas, proposals, and data in both professional and educational settings. Slide presentations include a series of slides, each of which can contain various content elements, including text, images, charts, and other media. Typically, users create slide presentations manually by selecting a layout, adding content elements such as text and images, and organizing these elements to effectively present their message. Recently, there have been efforts to incorporate data generation into the creation of slide presentations.

### SUMMARY

Embodiments of the present inventive concepts described herein include systems and methods for generating slide presentations based on an input prompt. Embodiments receive a prompt describing a slide presentation and, from the prompt, generate a presentation outline that represents the user's intent. The presentation outline consists of multiple sections, each with brief descriptions of the ideas to be conveyed, which the user can edit.

Embodiments then retrieve a set of relevant presentation templates that will be infilled with content. These templates are annotated with a “slide archetype,” which represents the general layout. The details of the layout, including element groups, text elements, image elements, and their positions, is obtained from an annotation process and represented in a knowledge graph.

Based on the user prompt and optional parameters (e.g., length, presentation type), embodiments select a suitable “recipe” that specifies the types of content to include and the slide archetypes. This recipe further filters the set of templates. Next, one of the viable templates is selected, and a content fitting operation is performed using the layout information embedded in the knowledge graph.

Embodiments ensure correct placement of any user-provided content and generate additional text or images as needed. A presentation structure document is created to define each slide and its contents. Embodiments traverse the knowledge graph to adjust the location and bounding boxes of the content as necessary. Finally, color corrections may be applied to ensure proper contrast. The completed presentation is then presented to the user, who may make further edits.

A method, apparatus, non-transitory computer readable medium, and system for generation of slide presentations are described. One or more aspects of the method, apparatus, non-transitory computer readable medium, and system include obtaining an input prompt describing a topic; generating, using a text generation model, a presentation outline based on the input prompt; generating a presentation structure based on the presentation outline, wherein the presentation structure includes a structured attribute indicating a slide layout element; and
generating a presentation on the topic based on the presentation structure, wherein the presentation comprises a slide including the slide layout element.

A method, apparatus, non-transitory computer readable medium, and system for generation of slide presentations are described. One or more aspects of the method, apparatus, non-transitory computer readable medium, and system include obtaining an input prompt; generating, using a text generation model, a presentation outline based on the input prompt; identifying a slide layout element based on a knowledge graph that includes the slide layout element (e.g., by traversing the knowledge graph comprising a slide archetype to identify the slide layout element); and generating a presentation based on the slide layout element, wherein the presentation comprises a slide including a content element corresponding to the slide layout element

An apparatus, system, and method for generation of slide presentations are described. One or more aspects of the apparatus, system, and method include a memory component; and a processing device coupled to the memory component, the processing device configured to perform operations comprising: obtaining an input prompt describing a topic; generating, using a text generation model, a presentation outline based on the input prompt; generating a presentation structure based on the presentation outline by traversing a knowledge graph comprising a slide archetype, wherein the slide archetype includes a slide layout element, and wherein the presentation structure includes a slide object including a structured attribute corresponding to the slide layout element; and performing a content fitting algorithm to generate a presentation based on the presentation outline, wherein the presentation comprises a slide corresponding to the slide object and including a content element corresponding to the structured attribute.

### BRIEF DESCRIPTION OF THE DRAWINGS

FIG. 1 shows an example of a presentation generation system according to aspects of the present disclosure.

FIG. 2 shows an example of a presentation generation apparatus according to aspects of the present disclosure.

FIG. 3 shows an example of a guided latent diffusion model according to aspects of the present disclosure.

FIG. 4 shows an example of a U-Net according to aspects of the present disclosure.

FIG. 5 shows an example of an annotation pipeline according to aspects of the present disclosure.

FIG. 6 shows an example of a knowledge graph according to aspects of the present disclosure.

FIG. 7 shows an example of a presentation structuring pipeline according to aspects of the present disclosure.

FIG. 8 shows an example of a presentation composing pipeline according to aspects of the present disclosure.

FIG. 9 shows an example of a presentation outline according to aspects of the present disclosure.

FIG. 10 shows an example of a presentation structure schema according to aspects of the present disclosure.

FIG. 11 shows an example of a filled presentation structure according to aspects of the present disclosure.

FIG. 12 shows an example of a method for providing a presentation to a user according to aspects of the present disclosure.

FIG. 13 shows an example of a method for generating a presentation based on an input prompt according to aspects of the present disclosure.

FIG. 14 shows an example of a computing device according to aspects of the present disclosure.

### DETAILED DESCRIPTION

Image processing techniques, such as image generation, are frequently used in creative workflows. Historically, users would rely on manual techniques and drawing software to create visual content. The advent of machine learning (ML) has enabled new workflows that automate the image creation process.

ML is a field of data processing that focuses on building algorithms capable of learning from and making predictions or decisions based on data. It includes a variety of techniques, ranging from simple linear regression to complex neural networks, and plays a significant role in automating and optimizing tasks that would otherwise require extensive human intervention.

Slide presentations are a common format for conveying information in a structured, visual manner. They are used to communicate ideas, proposals, and data in both professional and educational settings. Slide presentations include a series of slides, each of which contains various content elements such as text, images, charts, and other media. Traditionally, users create slide presentations manually by selecting a layout, adding these content elements, and organizing them to present their message clearly.

Recently, users have begun to incorporate generated content, such as images or text, into their slide presentations to reduce some of the manual effort. However, even with generated content, the creation process still requires substantial manual effort for each slide. Users must think of the sequence of ideas to include, arrange content appropriately, and ensure that the overall flow of the presentation conveys the intended message effectively.

There are conventional methods that can receive an input prompt and generate a presentation from it. These methods, however, are largely extractive, requiring extensive source material from which the system distills content down into slides. They depend heavily on pre-existing material to produce slides, which limits their flexibility. Some conventional methods also allow users to provide sparse input, such as a short prompt or topic, to generate a presentation. However, these one-click methods do not offer an editable presentation outline, preventing users from having granular control over the flow and structure of ideas. This lack of fine-tuned control often results in presentations that do not align perfectly with the user's intent. In such cases, the user will have to extensively edit the final slides by hand, or frequently start the entire process over.

In contrast, embodiments of the present inventive concepts improve the accuracy of presentation generation systems by generating a presentation outline that is editable by a user to guide the slide generation process, and then providing a fully prepared slide presentation that includes generated content elements that align with the user's input prompt. Rather than relying on purely extractive methods, embodiments generate a detailed presentation outline based on the user's input, which includes sections and brief descriptions of the ideas to be conveyed. This outline can be edited by the user to refine the flow and structure of the presentation. Embodiments also retrieve relevant templates annotated with slide archetypes and generate content-such as text, images, and layout elements-based on both the user's input and optional parameters like presentation length or type. The slide templates are annotated with their archetype and their particular layout in an annotation process that populates a knowledge graph and further involves extracting the positions and types of elements in the slides using image segmentation techniques and classifying the slides into their archetype. This structured approach allows the system to accurately generate and fit content into slide templates, ensuring alignment with the user's intent while offering granular control over the presentation's development. The result is a fully composed presentation with minimal manual effort required from the user.

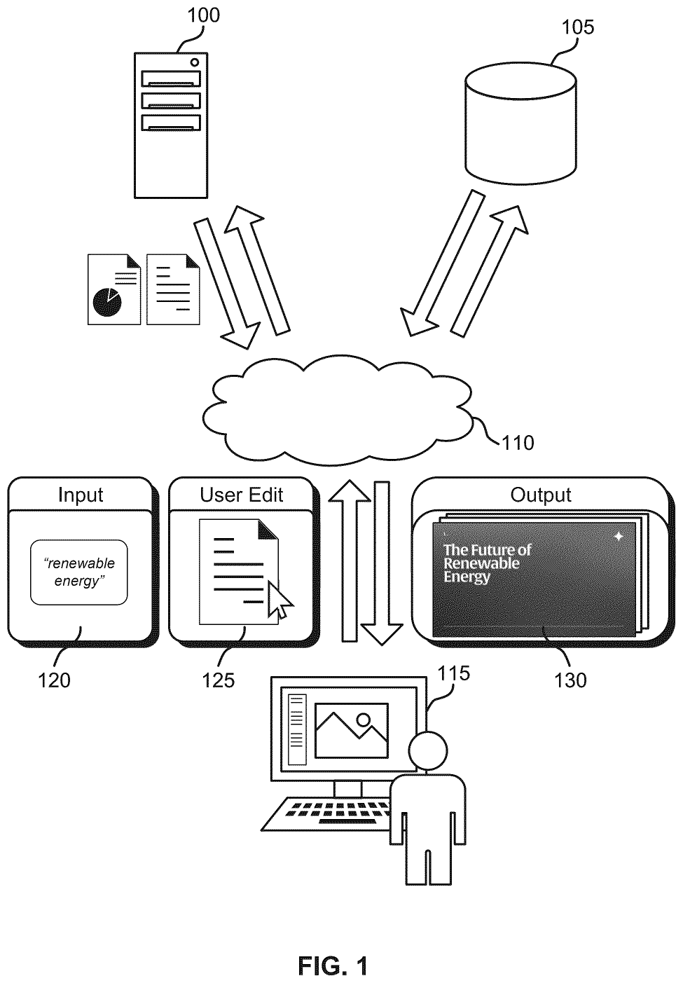

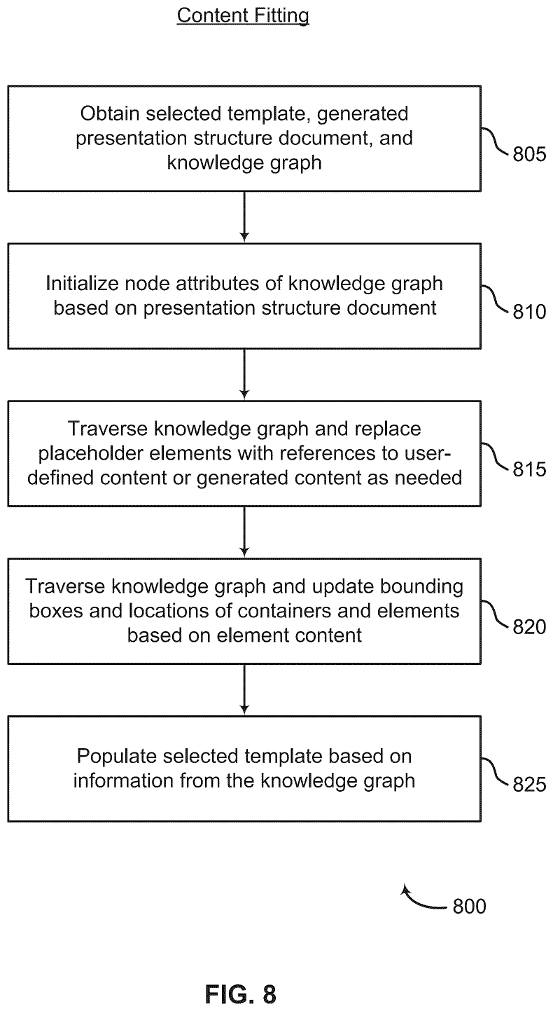

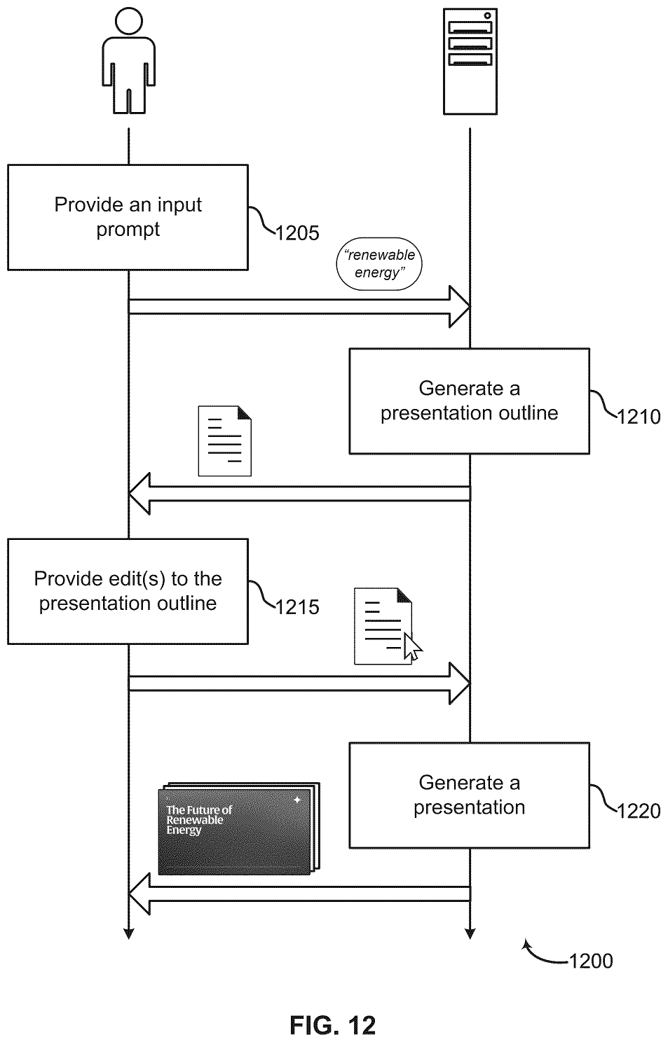

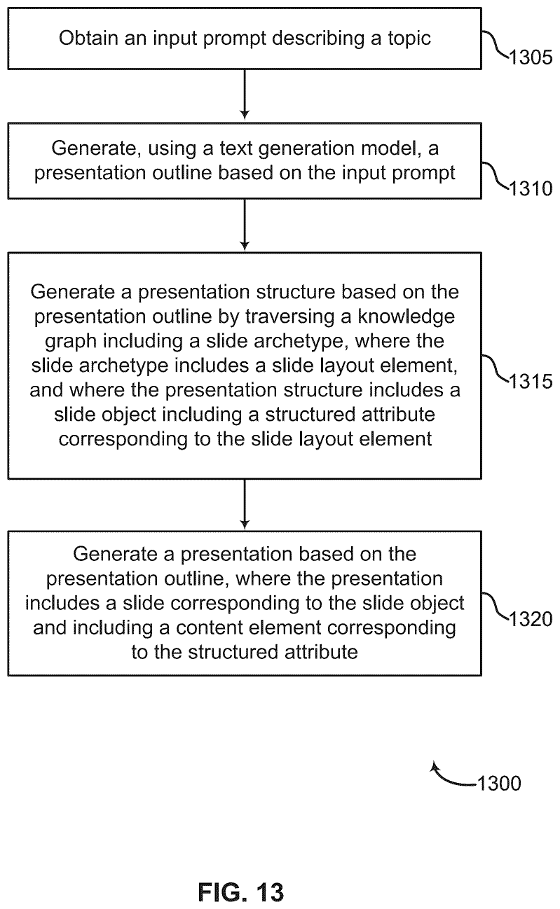

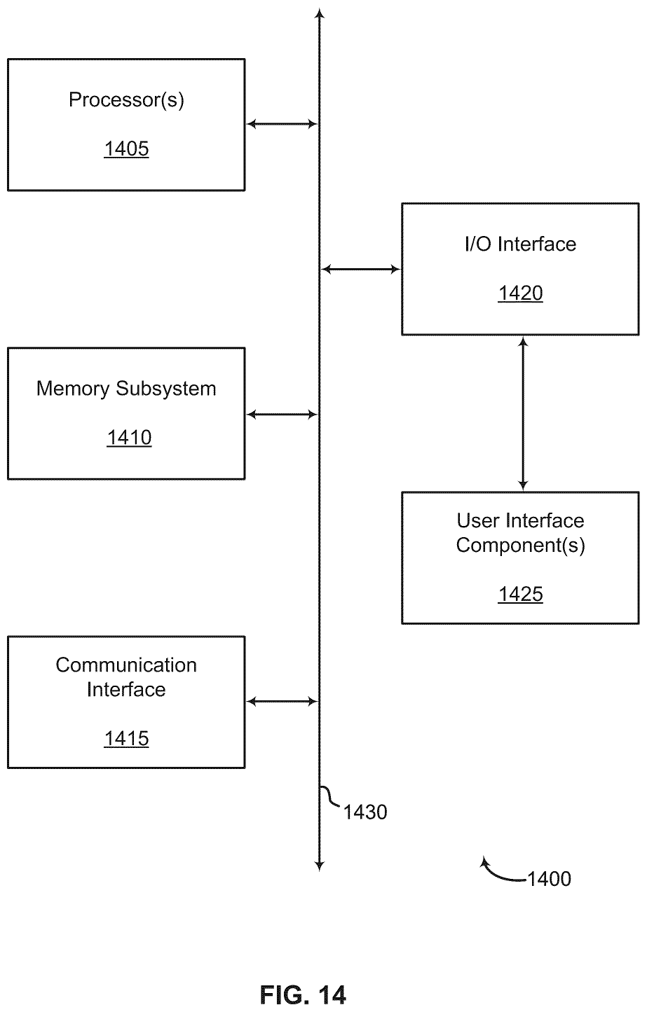

A presentation generation system is described with reference to FIGS. 1-7. A content fitting algorithm and example outputs of the system are described with reference to FIGS. 8-11. Methods for generating slide presentations are described with reference to FIGS. 12-13. A computing device configured to implement a presentation generation apparatus is described with reference to FIG. 14.

### Presentation Generation System

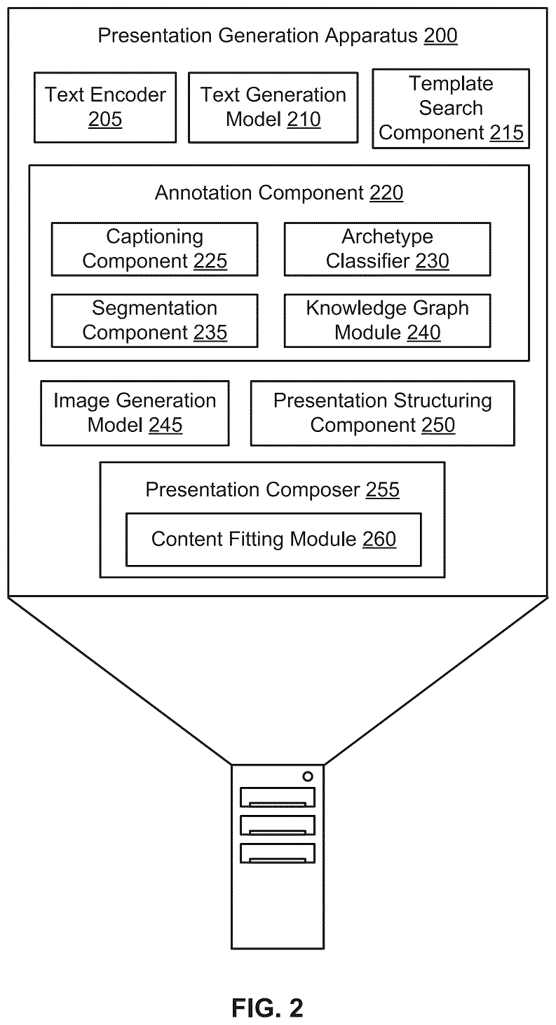

FIG. 1 shows an example of a presentation generation system according to aspects of the present disclosure. The example shown includes presentation generation apparatus 100, database 105, network 110, user interface 115, input prompt 120, user edit 125, and presentation 130. Presentation generation apparatus 100 is an example of, or includes aspects of, the corresponding element described with reference to FIG. 2.

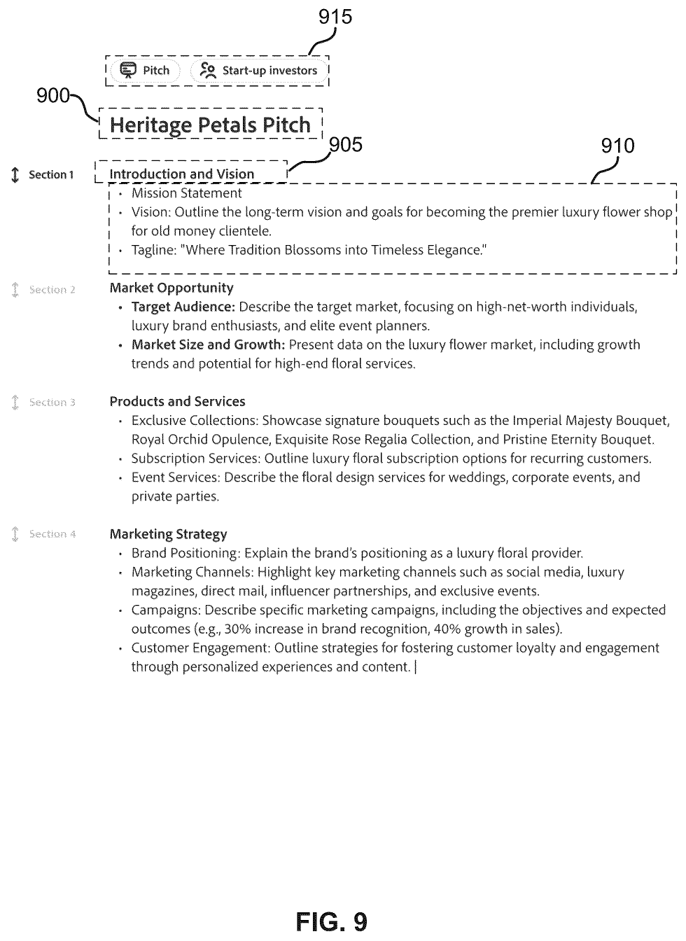

In one example, a user provides an input prompt that describes a presentation topic via user interface 115. The presentation generation apparatus 100 then generates a presentation outline that includes an ordered sequence of subtopics relating to the topic and displays it to the user. An example of the presentation outline is described with reference to FIG. 9. At this point, the user may make adjustments to the presentation outline as user edit 125 or may continue with the generation of the slides. Presentation apparatus 100 then generates a presentation slide deck that includes the subtopics from the presentation outline and presents it to the user via user interface 115. In some embodiments, the presentation apparatus 100 generates multiple variations of the presentation for the user with differing styles.

In some embodiments, one or more components of presentation generation apparatus 100 are implemented on a server. A server provides one or more functions to users linked by way of one or more of the various networks. In some cases, the server includes a single microprocessor board, which includes a microprocessor responsible for controlling all aspects of the server. In some cases, a server uses microprocessors and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a super computer, or any other suitable processing apparatus.

Database 105 is configured to store information used by the presentation generation system. For example, database 105 may store model parameters, stock texts, stock images, generated texts, generated images, presentation templates, and the like. A database is an organized collection of data. For example, a database stores data in a specified format known as a schema. A database may be structured as a single database, a distributed database, multiple distributed databases, or an emergency backup database. In some cases, a database controller may manage data storage and processing in a database. In some cases, a user interacts with the database controller. In other cases, the database controller may operate automatically without user interaction.

Network 110 facilitates the transfer of information between presentation generation apparatus 100, database 105, and a user, e.g., via user interface 115. In some cases, network 110 is referred to as a “cloud”. A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

A user interface 115 enables a user to interact with the presentation generation system. In some embodiments, user interface 115 may include an audio device, such as an external speaker system, an external display device such as a display screen, or an input device (e.g., remote control device interfaced with user interface 115 directly or through an IO controller module). In some cases, user interface 115 includes a graphical user interface 115 (GUI).

FIG. 2 shows an example of a presentation generation apparatus 200 according to aspects of the present disclosure. The example shown includes presentation generation apparatus 200, text encoder 205, text generation model 210, template search component 215, annotation component 220, image generation model 245, presentation structuring component 250, and presentation composer 255. Presentation generation apparatus 200 is an example of, or includes aspects of, the corresponding element described with reference to FIG. 1.

The presentation generation apparatus 200 described herein may include several components. These components are variously named and are described so as to partition the functionality enabled by the processor(s) and the executable instructions included in the computing devices used to implement the apparatuses (such as the computing device described with reference to FIG. 14). In some examples, the partitions are implemented physically, such as through the use of separate circuits or processors for each component. In some examples, the partitions are implemented logically via the architecture of the code executable by the processors.

The presentation generation apparatus 200 may include a processor and a memory. A processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor is configured to operate a memory array using a memory controller. In other cases, a memory controller is integrated into the processor. In some cases, the processor is configured to execute computer-readable instructions stored in a memory to perform various functions. In some embodiments, a processor includes special purpose components for modem processing, baseband processing, digital signal processing, or transmission processing.

A memory stores information used by presentation generation apparatus 200, such as data, instructions executable by a processor, machine learning model parameters, configurations, and the like. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

Text encoder 205 is configured to generate a text embedding from an input text. A text embedding is an information-rich vector representation of a text, which can used directly for measuring similarities with other texts/images or be decoded by an ML model for classification tasks or data generation tasks. Text generation model 210 may use the text embedding as a prompt to generate additional text. Template search component 215 may use the text embedding to find presentation templates by comparing the text embedding to one or more embedding(s) of a presentation template to measure similarity therebetween. Image generation model 245 may use the text embedding as conditioning features for generating image content. Embodiments of text encoder 205 include a transformer-based decoder such as sentence BERT or Flan-T5.

A transformer or transformer network is a type of neural network model used for natural language processing tasks. A transformer network transforms one sequence into another sequence using an encoder and a decoder. Encoder and decoder include modules that can be stacked on top of each other multiple times. The modules comprise multi-head attention and feed forward layers. The inputs and outputs (target sentences) are first embedded into an n-dimensional space. Positional encoding of the different words (i.e., give every word/part in a sequence a relative position since the sequence depends on the order of its elements) are added to the embedded representation (n-dimensional vector) of each word. In some examples, a transformer network includes attention mechanism, where the attention looks at an input sequence and decides at each step which other parts of the sequence are important. The attention mechanism involves query, keys, and values denoted by Q, K, and V, respectively. Q is a matrix that contains the query (vector representation of one word in the sequence), K are all the keys (vector representations of all the words in the sequence) and V are the values, which are again the vector representations of all the words in the sequence. For the encoder and decoder, multi-head attention modules, V consists of the same word sequence than Q. However, for the attention module that is taking into account the encoder and the decoder sequences, V is different from the sequence represented by Q. In some cases, values in V are multiplied and summed with some attention-weights a.

Text generation model 210 is configured to generate text based on an input, such as a text prompt. Embodiments of text generation model 210 generate the presentation outline, the presentation structure, and text content elements as described herein. A text generation model 210 is a type of neural network used to automatically generate text based on input data, such as a prompt or partial sentence. Text generation models are typically trained on large corpora of text data and utilize architectures like transformers to predict the next word in a sequence given the preceding context. In some examples, these models use layers of encoders and decoders, which process input text, transforming it into a sequence of word embeddings. The model generates text by sampling from the probability distribution of words predicted at each step.

In some cases, text generation models include mechanisms for attention, which allow the model to focus on specific parts of the input sequence when predicting the next word. This attention mechanism involves components such as query, key, and value matrices, which help the model weigh the importance of different input words when generating output. In addition, models can be fine-tuned to follow specific stylistic guidelines or to generate text for a particular domain.

According to some aspects, text generation model 210 generates a presentation outline based on the input prompt. In some aspects, the presentation outline includes a set of sections, and where each of the set of sections includes at least one key point corresponding to the topic. In some aspects, the content element that is included in the generated presentation is generated using the text generation model 210.

Embodiments of template search component 215 create a template database in a first phase, and then obtain relevant templates to an input prompt during an input phase. In an example first phase, a larger set of presentation templates are filtered based on a number of slides in the template and the slide content. This ensures that the presentation slides cover multiple scenarios and cover many different types of slides. For example, this ensures that not all slides in a template are Chapter-type slides.

The template search component 215 obtains text definitions from the presentation templates from annotation component 220. In some embodiments, template search component 215 also obtains additional attributes from the presentation templates, including style and mood descriptions, target audience descriptions, and the like. The definition and other obtained attributes are encoded, e.g., using text encoder 205, and stored in a vector database.

At inference time, the template search component 215 obtains a text embedding of the input prompt and searches the database for a template T which maximizes the weighted sum of cosine similarity scores between the template attributes and the input prompt/other user selected attributes. In one example, this maximization is described by:

$${max}_{T} {\sum }_{I} {W}_{I} 〈 S ( {I}_{U} ) , S ( {I}_{T} ) 〉 \qquad ( 1 )$$

where S denotes a sentence similarity model, <.,.> represents the cosine similarity between the embeddings, U and T indexes represent the origin of the element I, which is one of the 4 embedded sequences: Intent, mood, style or target audience. W, is the weight associated with element I.

Annotation component 220 is configured to add semantic annotations to presentation templates either in a separation annotation phase or during use of presentation generation apparatus 200. In one aspect, annotation component 220 includes captioning component 225, archetype classifier 230, segmentation component 235, and knowledge graph module 240. Embodiments of captioning component 225, archetype classifier 230, and segmentation component 235 include a vision transformer. A vision transformer (e.g., a ViT model) is a neural network model configured for computer vision tasks. Unlike CNNs, ViTs use a transformer architecture, which was originally developed for natural language processing (NLP) tasks. ViTs break down an input image into a sequence of patches, which are then fed through a series of transformer encoder layers. The output of the final encoder layer is fed into a multi-layer perceptron (MLP) head for classification. ViTs can capture long-range dependencies between patches without relying on spatial relationships.

Captioning component 225 is configured to generate a descriptive text about an image. Captioning component 225 may be an image-to-text model configured to generate a caption or label for an input image. For example, captioning component 225 may include a CLIP model, a BLIP-2 model, a LLaVA caption model, or the like. According to some aspects, captioning component 225 processes images of the slides in a presentation template to generate a template definition, which is one of the attributes that is considered when template search component 215 searches for relevant presentation templates.

Archetype classifier 230 is configured to process an image of a slide in a template and classify the slide as a particular archetype. Embodiments of archetype classifier include but are not limited to an artificial neural network (ANN) such as the ViT described above, or an MLP. In some embodiments, the set of slide archetypes includes Cover, Chapter, Chapter with media, Cover With Media, Agenda, Content, Content with lists, Content with Media and Thank you slides. These archetypes may be associated with an integer identifier.

Segmentation component 235 segments an image of a slide to identify the elements it contains and their locations. In digital image processing and computer vision, image segmentation is the process of partitioning a digital image into multiple segments (sets of pixels, also known as image objects). The goal of segmentation is to simplify and/or change the representation of an image into something that is more meaningful and easier to analyze. Image segmentation is typically used to locate objects and boundaries (lines, curves, etc.) in images. More precisely, image segmentation is the process of assigning a label to every pixel in an image such that pixels with the same label share certain characteristics. These pixel labels may be associated with a text label, and in some cases, a bounding box that identifies the location of the segmented object.

In some embodiments, a segmentation component 235 may include models such as SAM (Segment Anything Model), SEM (Segment Everything Model), or YOLO (You Only Look Once), which have been fine-tuned to focus on identifying elements in presentation slides. These models may be configured to segment and label elements like titles, subtitles, text regions, and images within the slides.

Knowledge graph module 240 maintains a knowledge graph representation of one or more presentation templates. A knowledge graph is a structured representation of information, where entities (nodes) are connected by relationships (edges) to represent various types of data and their associations. Knowledge graphs are commonly used to organize and link data in a way that reflects real-world relationships, making it easier to perform queries and draw insights from the connected information. In computer systems, a knowledge graph can be used to model relationships between various objects, capturing both the entities and their interactions in a graph-based format.

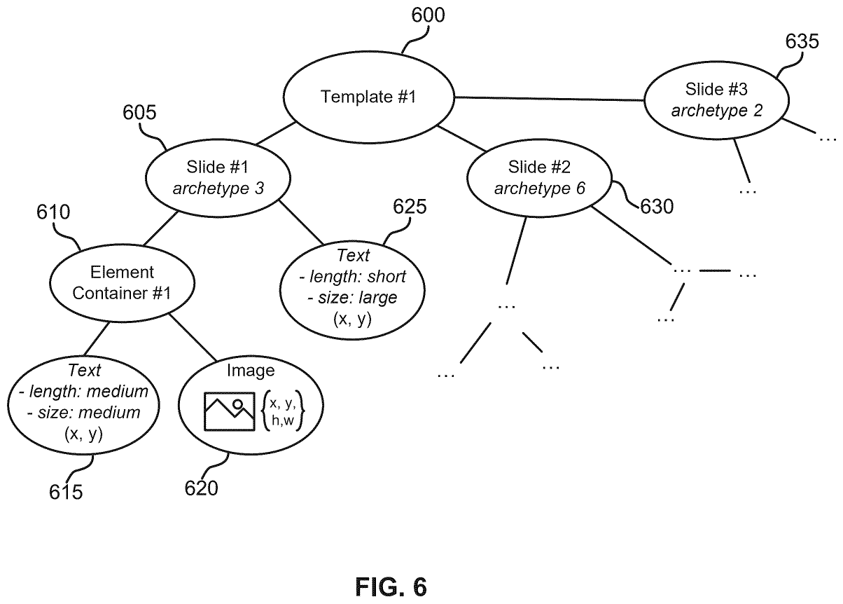

In some embodiments, a knowledge graph representation may be used to model the structure of presentation templates and slides. For instance, the graph may represent “ownership” or “containment” hierarchies within a slide, where groups of elements can include other groups or slide components, such as text boxes or images. This hierarchical representation enables the system to map out relationships between different parts of the presentation. Machine learning techniques may also be applied to or used in conjunction with knowledge graphs to enhance the system's ability to organize and interpret the data represented in the graph. An example knowledge graph is described with reference to FIG. 6.

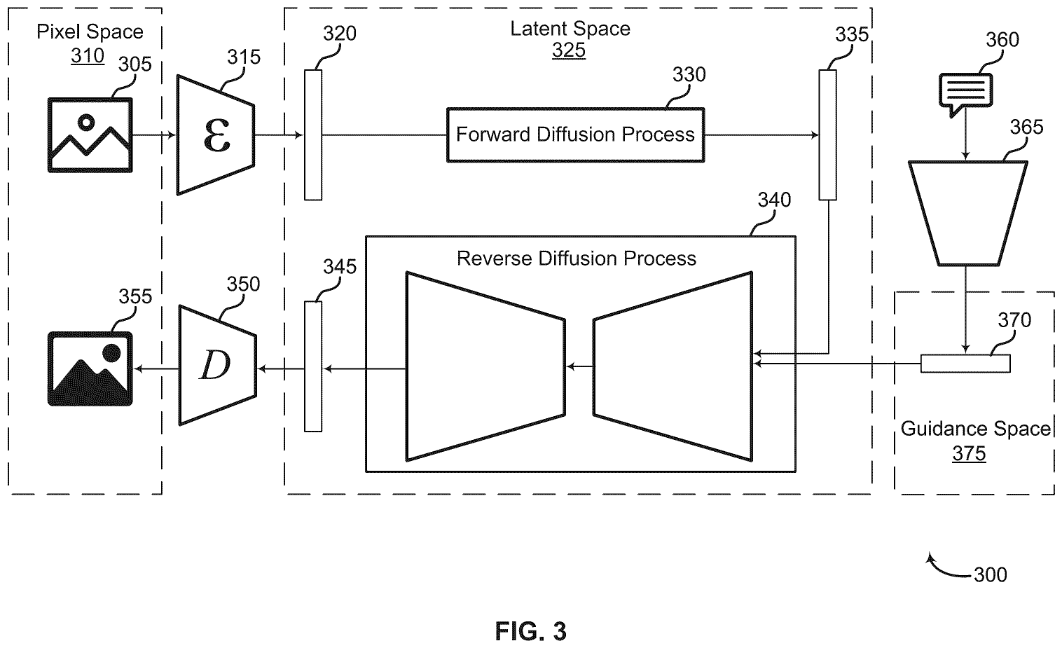

Image generation model 245 generates images based on a text prompt. In some embodiments, the text generation model generates generative prompts that are stored in a presentation structure document. When the prompt is indicated as an image content prompt, the system inputs the prompt into image generation model 245 to obtain a corresponding image content for the presentation. Embodiments of image generation model 245 include, but are not limited to, a guided latent diffusion model. Such a model is described in detail with reference to FIG. 3.

Embodiments utilize image generation model 245 to provide additional visual content to fill spaces in the presentation that do not include user provided content. Embodiments may additionally obtain visual content via a stock search process as well. For example, text generation model 210 may generate a description of the desired visual that can be used as a prompt for the image generation model 245 or as a search term. If the prompt outline contains a slide title “Solar Power Innovations” and a slide subtitle “Harnessing the Power of the Sun”, the text generation model may generate a prompt/search query as “image of advanced solar panels and solar farms with modern technology.” The system may then obtain relevant images from a stock database by using standard search techniques, such as searching by comparing the similarities of embeddings of the search prompt and the image labels.

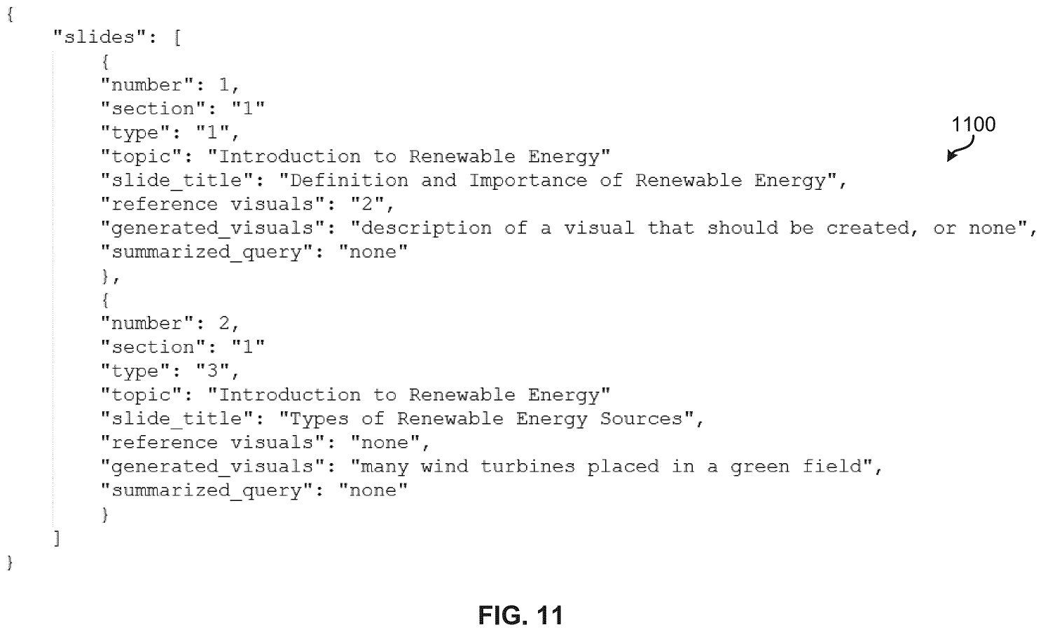

Presentation structuring component 250 generates a document referred to herein as “a presentation structure” that defines the content to be included in every slide of the final generated presentation. According to some aspects, presentation structuring component 250 generates a presentation structure based on the presentation outline by traversing a knowledge graph including a slide archetype, where the slide archetype includes a slide layout element, and where the presentation structure includes a slide object including a structured attribute corresponding to the slide layout element. In some aspects, the slide layout element includes a title element, a text element, an image element, or any combination thereof. In some examples, presentation structuring component 250 updates a value attribute of a node of the knowledge graph to include a value of the content element. In some examples, presentation structuring component 250 updates a location attribute of a node of the knowledge graph based on the value attribute of a parent node. An example presentation structure is described with reference to FIG. 11.

Presentation composer 255 filles out a selected presentation template with content by referencing the presentation structure and the knowledge graph stored within knowledge graph module 240. According to some aspects, presentation composer 255 generates a presentation based on the presentation outline, where the presentation includes a slide corresponding to the slide object and including a content element corresponding to the structured attribute. In one aspect, presentation composer 255 includes content fitting module 260. The content fitting module performs a content fitting operation. A content fitting operation is described with reference to FIG. 8.

FIG. 3 shows an example of a guided latent diffusion model 300 according to aspects of the present disclosure. The guided latent diffusion model 300 depicted in FIG. 3 is an example of, or includes aspects of, the image generation model 245 described with reference to FIG. 2.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 300 may take an original image 305 in a pixel space 310 as input and apply and image encoder 315 to convert original image 305 into original image features 320 in a latent space 325. Then, a forward diffusion process 330 gradually adds noise to the original image features 320 to obtain noisy features 335 (also in latent space 325) at various noise levels.

Next, a reverse diffusion process 340 (e.g., a U-Net ANN) gradually removes the noise from the noisy features 335 at the various noise levels to obtain denoised image features 345 in latent space 325. In some examples, the denoised image features 345 are compared to the original image features 320 at each of the various noise levels, and parameters of the reverse diffusion process 340 of the diffusion model are updated based on the comparison. Finally, an image decoder 350 decodes the denoised image features 345 to obtain an output image 355 in pixel space 310. In some cases, an output image 355 is created at each of the various noise levels. The output image 355 can be compared to the original image 305 to train the reverse diffusion process 340.

In some cases, image encoder 315 and image decoder 350 are pre-trained prior to training the reverse diffusion process 340. In some examples, they are trained jointly, or the image encoder 315 and image decoder 350 and fine-tuned jointly with the reverse diffusion process 340.

The reverse diffusion process 340 can also be guided based on a text prompt 360, or another guidance prompt, such as an image, a layout, a segmentation map, etc. The text prompt 360 can be encoded using a text encoder 365 (e.g., a multimodal encoder) to obtain guidance features 370 in guidance space 375. The guidance features 370 can be combined with the noisy features 335 at one or more layers of the reverse diffusion process 340 to ensure that the output image 355 includes content described by the text prompt 360. For example, guidance features 370 can be combined with the noisy features 335 using a cross-attention block within the reverse diffusion process 340. The process may be repeated to generate frames of a video or may be carried out on a spectrogram data and passed through a vocoder to generate sound. According to some aspects, diffusion models that are used to generate videos and/or sound may include additional architectural adaptations, such as temporal layers that ensure coherency between frames or waveforms.

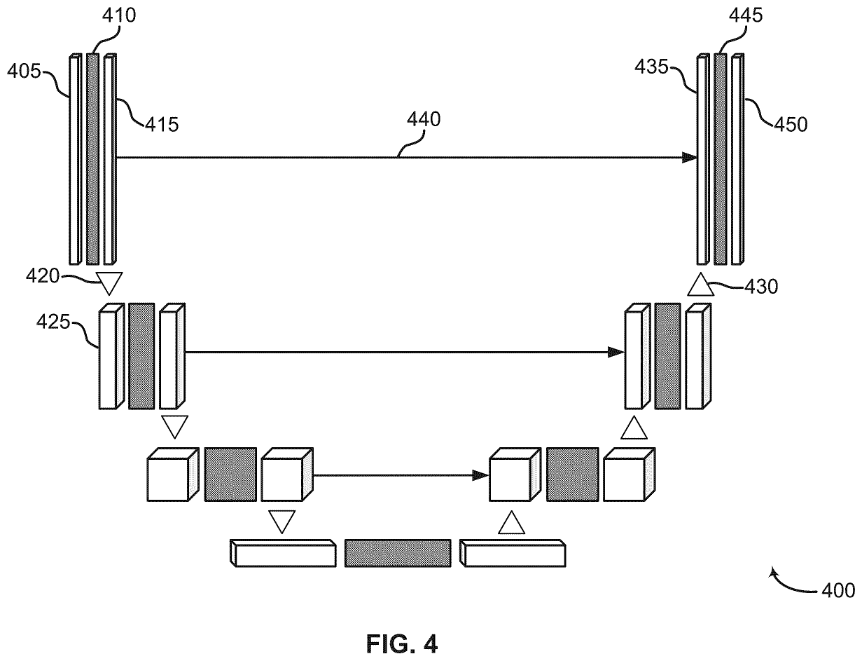

FIG. 4 shows an example of a U-Net 400 according to aspects of the present disclosure. In some examples, U-Net 400 is an example of the component that performs the reverse diffusion process 340 of guided diffusion model 300 described with reference to FIG. 3 and includes architectural elements of the image generation model 245 described with reference to FIG. 2.

In some examples, diffusion models are based on a neural network architecture known as a U-Net. The U-Net 400 takes input features 405 having an initial resolution and an initial number of channels and processes the input features 405 using an initial neural network layer 410 (e.g., a convolutional network layer) to produce intermediate features 415. The intermediate features 415 are then down-sampled using a down-sampling layer 420 such that down-sampled features 425 have a resolution less than the initial resolution and a number of channels greater than the initial number of channels.

This process is repeated multiple times, and then the process is reversed. That is, the down-sampled features 425 are up-sampled using up-sampling process 430 to obtain up-sampled features 435. The up-sampled features 435 can be combined with intermediate features 415 having a same resolution and number of channels via a skip connection 440. These inputs are processed using a final neural network layer 445 to produce output features 450. In some cases, the output features 450 have the same resolution as the initial resolution and the same number of channels as the initial number of channels.

In some cases, U-Net 400 takes additional input features to produce conditionally generated output. For example, the additional input features could include a vector representation of an input prompt. The additional input features can be combined with the intermediate features 415 within the neural network at one or more layers. For example, a cross-attention module can be used to combine the additional input features and the intermediate features 415. Embodiments of the image generation model described herein may combine anchor features in a similar manner, but instead of adding the influence of the anchor features, embodiments may subtract the influence. This can be achieved by computing attention weights for the anchor features and then subtracting the resulting weighted features from the intermediate features 415. By doing so, the model reduces the presence of elements associated with the anchor features in the generated output.

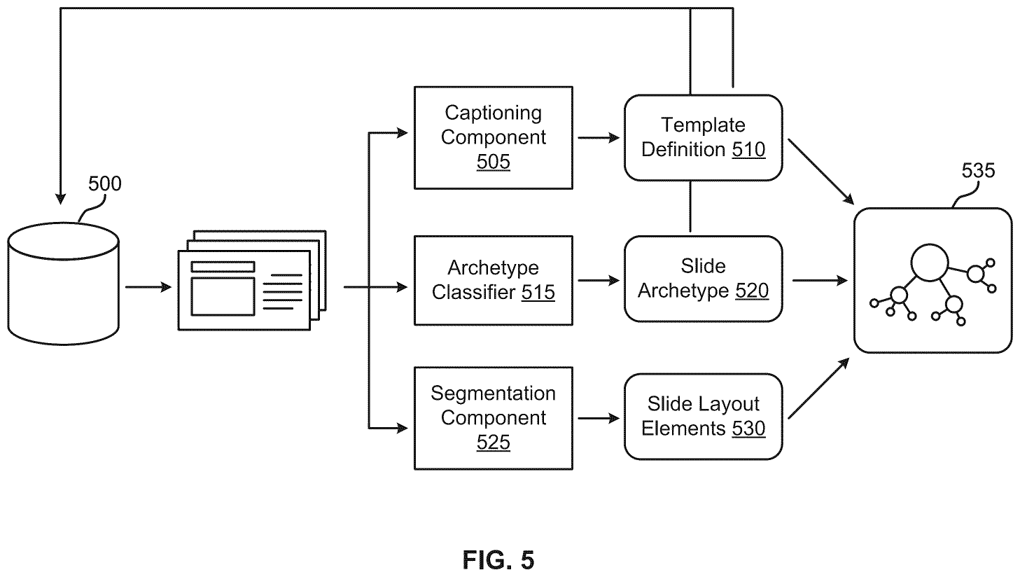

FIG. 5 shows an example of an annotation pipeline according to aspects of the present disclosure. The example shown includes template database 500, captioning component 505, template definition 510, archetype classifier 515, slide archetype 520, segmentation component 525, slide layout elements 530, and knowledge graph module 535. Captioning component 505, archetype classifier 515, segmentation component 525, and knowledge graph module 535 are examples of, or include aspects of, the corresponding elements described with reference to FIG. 2.

Embodiments may perform an annotation process to a slide template either prior to or during presentation generation. The following will describe an example in which a single presentation template is annotated, for simplicity.

In this example, embodiments obtain a presentation template from template database 500. The presentation template may include a plurality of slides of different types, such as Chapter slides, Cover slides, Content with media slides, and the like. Each slide may include one or more placeholder elements, such as an image or text. The presentation template is passed as input to captioning component 505, archetype classifier 515, and segmentation component 525.

Captioning component 505 processes the slides from the template as images and generates captions for each slide. Examples of the captioning component include a captioning model such as BLIP-2, CLIP, or LLaVA. The slide captions may be combined or processed by a text generation model to obtain a template definition 510. The template definition may be stored as text, or encoded into a vector representation, and associated with the template in the template database 500. In some embodiments, the template definition 510 is added as a value to a template node in the knowledge graph stored in knowledge graph module 535.

Archetype classifier 515 processes the slides from the template as images and classifies each slide as a slide archetype. To encourage slide reusability, mixing and reordering, each slide is labeled with one archetype. This approach enables utilizing the same slide template multiple times within a presentation and also provides a generic overview for each slide, that can easily be explained to a text generation model to provide a presentation structure. In some embodiments, each archetype is also paired with a textual description that can improve the LLM (e.g., the text generation model) performance in designing a presentation.

In some examples, the slide archetype taxonomy includes the following slide archetypes: Cover, Chapter, Chapter with media, Cover With Media, Agenda, Content, Content with lists, Content with Media and Thank you slides. While usually slides are conceptually different, certain types that contain media elements are also included as different classes. This classification strategy allows control over how visual the presentation is and also improves the overall presentation quality. Studies have shown that high quality presentations have few different slide types and alternate between them in order to avoid a monotonous tone. The classified archetype may be associated with the slide of the template and stored in template database 500. The slide archetype 520 may also be inserted as a value into a slide node of the knowledge graph.

Segmentation component 525 processes the slides from the template as images and identifies individual content elements, such as text boxes, images, titles, subtitles, and the like. The segmentation is performed by applying a grouping and element labeling strategy that has been trained on a dataset of manually annotated slides. This strategy identifies the boundaries and labels of each element within the slide image. Once the individual labels are obtained, a mapping is performed to align the labels with a ground-truth document model (i.e., the underlying content of the slide). For individual elements, the mapping is based on maximizing the intersection over union (IoU) between the labels detected in the image and the corresponding document model elements. For groups of elements, any element with more than 10% of its area covered by a detected group is considered part of that group. This finetuning process trains the segmentation component 525 to generalize to new presentation templates and accurately identify what types of slide elements it contains and their locations and bounding boxes. The identified slide layout elements 530 including the locations, bounding boxes, and element types may be stored as values of leaf nodes to the slide node in the knowledge graph. Accordingly, the annotation pipeline prepares presentation templates for use in presentation generation.

FIG. 6 shows an example of a knowledge graph according to aspects of the present disclosure. The example shown includes template node 600, first slide node 605, element container node 610, first slide layout element node 615, second slide layout element node 620, third slide layout element node 625, second slide node 630, and third slide node 635.

In this example, a presentation template is represented in a root node as template node 600. Though no values are depicted for the root node in FIG. 6, embodiments are not limited thereto, and the template node 600 may have a value for, e.g., a template definition as described above. According to some aspects, the children nodes of template node 600 are slide nodes. First slide node 605 represents a slide of the presentation template. It may have one or more values stored in in the node, such as its slide archetype. First slide node 605 includes children nodes that represent the contents of the slide as determined during the annotation process. For example, one of its children is element container node 610, which includes two children nodes (leaf nodes in this example), which are first slide layout element node 615 and second slide layout element node 620.

First slide layout element node 615 represents a text content element in this case. In this example, the first slide layout element node 615 may include multiple values, such as a placeholder text value, a length value (which can be programmatically obtained from its text value), a size value (e.g., a font size), and a location in a 2D space of the slide, such as a pixel location. In some embodiments, the node further includes a value to represent the element's bounding box. The other leaf node in the container, second slide layout element node 620, represents an image content element. The image content element may store an image or a reference to an image, such as a URL, an integer identifier, or similar. The image content element may also include position and bounding box information. Third slide layout element node 625 may be a text node similar to first slide layout element node 615 but may have different attributes and does not belong within an element container. Second slide node 630 and third slide node 635 also represent slides, have their own slide archetype values, and their own children nodes.

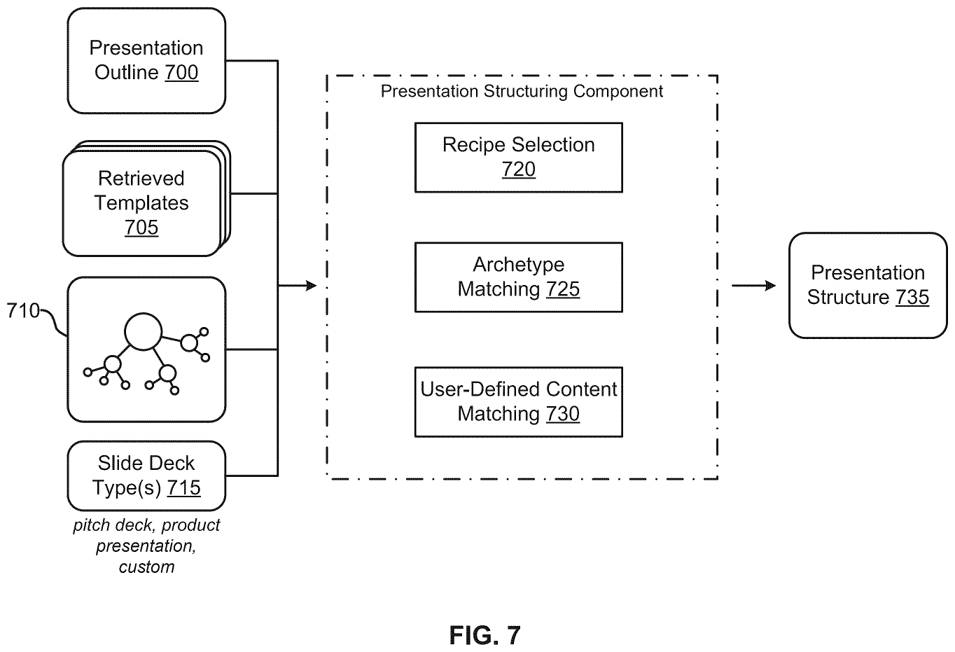

FIG. 7 shows an example of a presentation structuring pipeline according to aspects of the present disclosure. The example shown includes presentation outline 700, retrieved templates 705, knowledge graph 710, slide deck type(s) 715, recipe selection 720, archetype matching 725, user-defined content matching 730, and presentation structure 735.

Presentation outline 700 serves as the starting point for structuring the final presentation. It was previously generated from an input prompt by a text generation model as described with reference to FIG. 2. It includes multiple sections, each with brief descriptions of the ideas to be conveyed, which may have been edited by the user. This outline provides a high-level roadmap of the presentation's flow and content. Retrieved templates 705 include annotated templates, each labeled with slide archetypes that define the general layout of the slides and their corresponding content elements. These templates help shape the structure of the presentation by providing a variety of pre-configured designs. The knowledge graph 710 holds much of the annotation for these templates. It represents each template hierarchically, with the template as the root node, slide nodes as children, and each slide node's children detailing the size and position of the slide content elements, such as text boxes and images. This structure allows the system to effectively navigate and assign content to specific areas within the slides.

Slide deck type(s) 715 are an optional input provided by the user. These can describe the desired type of presentation, such as a Sales Pitch or Research Presentation, and can also include details about the intended audience or the desired length of the presentation. If the user does not specify a slide deck type, the system can infer suitable structures based on the presentation outline and any other user-provided inputs, such as the initial prompt.

Recipe selection 720 is the first sub-operation of the presentation structuring component. It determines a presentation recipe based on the slide deck type(s) provided. This recipe defines the types of content to include in the presentation and the preferred structure for conveying the ideas effectively. For example, a status update presentation might prioritize lists and sparse visuals, while a presentation for schoolchildren might emphasize more visuals and fewer text-heavy slides. If no slide deck type is provided, the system can generate the recipe by analyzing the presentation outline or other user inputs.

Archetype matching 725 is the next sub-operation, where the system identifies the most suitable slide archetypes for conveying the ideas outlined in the presentation. This process is based on both the selected recipe and the presentation outline. Archetype matching further filters the set of available templates to ensure that each slide's layout matches the content requirements and flow of the presentation. Embodiments utilize slide designs that best suit the intended message while adhering to the recipe.

User-defined content matching 730 is the process of assigning user-provided content—such as specific images or text—to appropriate locations within the selected slides. This process takes precedence over automatically generated content and ensures that any content the user has provided is placed correctly. The knowledge graph is used to inform this matching process by identifying salient areas within the slide layouts that are most appropriate for the user's content.

The output of these operations is the presentation structure 735, which defines each slide and its contents. This structure ensures that the final presentation aligns with the user's input, both in terms of content and layout, while also adhering to the selected recipe and archetypes. The presentation structure 735 further includes generation prompts for any slide contents that were not filled by the user-defined content. When composing the presentation, the presentation generation system will reference the generation prompts to generate these contents using the text generation model and the image generation model as described with reference to FIG. 2.

FIG. 8 shows an example of a method 800 a presentation composing pipeline according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 805, the system obtains the selected presentation template, the generated presentation structure document (as described with reference to FIG. 7), and the knowledge graph. The presentation template, obtained during earlier stages, includes annotated placeholder values for content elements, such as text and images. The knowledge graph is initialized with these annotations and provides a hierarchical structure for the slides and their content elements.

At operation 810, the system initializes the node attributes of the knowledge graph based on the presentation structure document. The knowledge graph, which includes nodes for slide content elements, slide layouts, and element bounding boxes, is populated with default or placeholder values from the selected presentation template. The presentation structure document provides instructions regarding content placement and layout, which the system uses to prepare the knowledge graph for further processing.

At operation 815, the system traverses the knowledge graph and replaces the placeholder elements with references to user-defined content or generated content, as needed. During this step, the system ensures that any user-provided content (such as specific text or images) is prioritized and placed into the appropriate slots in the slides. For any remaining placeholder elements that are not filled by user-defined content, the system generates content (such as text or images) using text generation models or image generation models. This operation ensures that all content slots within the knowledge graph are filled in alignment with the presentation structure document.

At operation 820, the system traverses the knowledge graph again to update the bounding boxes and locations of the containers and elements based on the replaced content. As the content in the knowledge graph changes (e.g., user-defined content or generated content replaces placeholder content), the system adjusts the layout to ensure proper fit and alignment. This step updates the sizes, positions, and bounding boxes of the content elements within the slides, ensuring that the final presentation layout is cohesive and visually accurate.

At operation 825, the system populates the selected template using the updated knowledge graph. The information from the knowledge graph, including the final content, bounding boxes, and locations of the elements, is used to complete the slide presentation. At this point, any remaining generative operations, such as finalizing image or text generation or obtaining stock images or stock texts, are carried out to ensure that the slide presentation is fully populated and ready for user review.

### System Outputs

FIG. 9 shows an example of a presentation outline according to aspects of the present disclosure. The example shown includes presentation title 900, first section title 905, first content list 910, and slide deck type(s) 915. Slide deck type(s) is an example of, or includes aspects of, the corresponding element described with reference to FIG. 7.

The presentation outline may be generated from a user-input prompt, such as “a presentation about Heritage Petals, a luxury flower shop.” The presentation outline is generated using a text generation model as described with reference to FIG. 2. The text generation model may be, for example, a large language model (LLM), and the system may condition the user-input prompt with additional instructions such as a desired outline format. The presentation outline may be stored in a markup or JSON format on the backend, which is presented for editing in a natural interface as depicted in FIG. 9.

The presentation outline has several values that can be edited by the user at this stage, which will influence the structure and content of the final presentation. For example the user may change presentation title 900, first section title 905, the first content list 910, and the slide deck type(s) 915. The system may process this updated presentation outline to generate a presentation structure using the operations described with reference to FIG. 7.

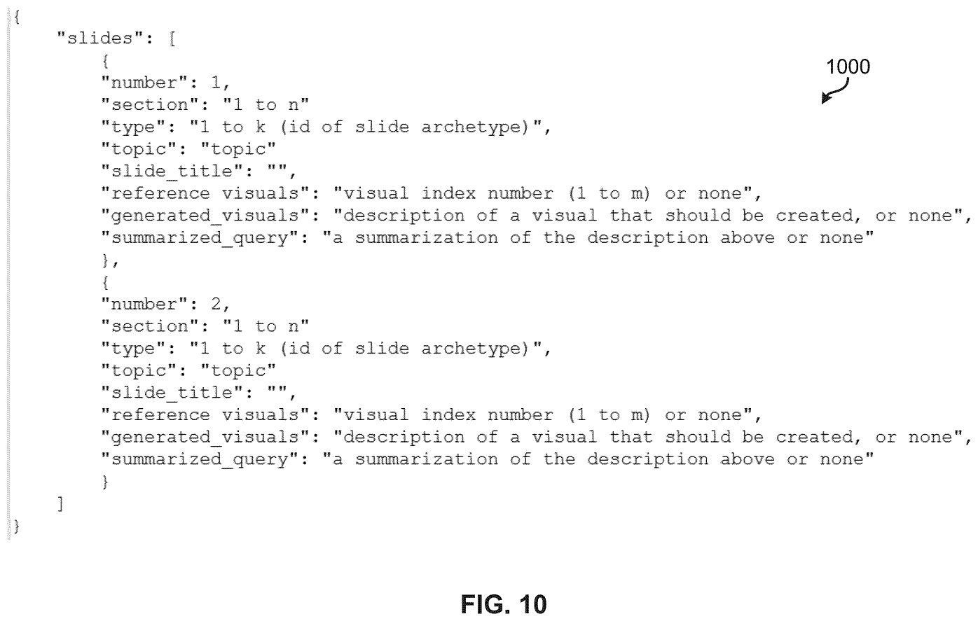

FIG. 10 shows an example of a presentation structure schema according to aspects of the present disclosure. The example shown may represent an additional conditioning prompt that is provided to a text generation model to constrain the text generation model's outputs to adhere to the schema. The schema includes a list of structured attributes, that is, keys and values, that control the structure of the final generation.

Some of the structured attributes include the “slides” attribute, which contains a list of slide objects, each corresponding to a slide in the presentation. Each slide object contains several fields, such as the “number” field, which identifies the sequential position of the slide within the presentation. The “section” field maps each slide to one of the predefined sections from the presentation outline, while the “type” field identifies the slide archetype, referring to the layout or design type selected from a set of available archetypes.

Additionally, each slide object contains a “topic” field that defines the main topic or subject of the slide, along with a “slide_title” field that may be left blank for auto-generation or filled by the user. The schema also includes visual elements, specified by the “reference visuals” field, which refers to an indexed visual already present in the knowledge graph, or the “generated_visuals” field, which contains a description of any visual that should be generated. If a slide requires automatic content generation, the “summarized_query” field may provide a summary of the description or the main points that the slide needs to convey, serving as an input to the content generation models.

FIG. 11 shows an example of a filled presentation structure according to aspects of the present disclosure. This example demonstrates how the system fills out the presentation structure based on the recipe selection, archetype matching, user-defined content matching, and content fitting algorithms, as described with reference to FIGS. 7 and 8. The structured attributes now contain populated values, with each slide being assigned a specific section, slide archetype, and topic.

In this example, slide number 1 belongs to section 1 and is of slide archetype 1, with the topic “Introduction to Renewable Energy.” The title for this slide, “Definition and Importance of Renewable Energy,” has been generated or specified. The “reference visuals” field points to visual index 2, indicating a pre-existing visual element, while the “generated_visuals” field remains empty, meaning no additional visual is required. The “summarized_query” field is also set to “none.”

Slide number 2, also in section 1, is of archetype 3 and continues the topic of “Introduction to Renewable Energy.” This slide's title is “Types of Renewable Energy Sources,” and the “generated_visuals” field specifies the creation of a visual showing “many wind turbines placed in a green field.” No reference visual is used here, and the “summarized_query” remains “none.”

### Presentation Generation

FIG. 12 shows an example of a method 1200 for providing a presentation to a user according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1205, the user provides an input prompt. The user may do so via a user interface as described with reference to FIG. 1. The input prompt may describe a presentation topic.

At operation 1210, the system generates a presentation outline. The operations of this step may be performed by a text generation model as described with reference to FIG. 2. The presentation outline includes an ordered sequence of subtopics relating to the topic from the input prompt. An example of the presentation outline is described with reference to FIG. 9.

At operation 1215, the user provides edit(s) to the presentation outline. For example, the user may add or delete sections, change section titles, and alter the contents within the section. The user may do so via the user interface as described above.

At operation 1220, the system generates a presentation. To begin, the system obtains a presentation template, which includes pre-annotated layouts such as slide archetypes, content element placeholders, and design structures. This template is linked to a knowledge graph, which organizes the hierarchical relationships of the slides and their content elements, such as text boxes, images, and other media components. The knowledge graph contains nodes representing slides, and the slide element nodes include attributes like size, position, and content placeholders.

Next, the system generates a presentation structure document, as described with reference to FIG. 7. This document defines the layout and content for each slide based on the presentation outline and any user edits. It specifies slide titles, topics, and visual elements, as well as placement and arrangement instructions drawn from the template and knowledge graph.

Using this structure document, the system populates the presentation template by traversing the knowledge graph and filling in the placeholders with user-provided content or, when necessary, generating new content via text generation or image generation models. The system also adjusts the sizes, locations, and bounding boxes of the content elements to ensure the slides maintain a coherent and visually appealing layout. The presentation is then generated according to the selected template and user input.

In some cases, the system may generate multiple variants of the presentation by applying different templates to the same outline, offering the user various stylistic and structural options. These variations allow the user to select the best fit for their intended audience or presentation style. The system then provides the generated presentation(s) to the user via the user interface.

FIG. 13 shows an example of a method 1300 for generating a presentation based on an input prompt according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1305, the system obtains an input prompt describing a topic. In some cases, the operations of this step refer to, or may be performed by, a presentation generation apparatus as described with reference to FIGS. 1, 2, and 12. The input prompt may include a high-level description of the topic and is used as the starting point for generating the presentation.

At operation 1310, the system generates, using a text generation model, a presentation outline based on the input prompt. In some cases, the operations of this step refer to, or may be performed by, a text generation model as described with reference to FIG. 2. The presentation outline includes an ordered sequence of subtopics that correspond to different sections of the presentation. An example of a presentation outline is described with reference to FIG. 9.

At operation 1315, the system generates a presentation structure based on the presentation outline by traversing a knowledge graph including a slide archetype, where the slide archetype includes a slide layout element, and where the presentation structure includes a slide object including a structured attribute corresponding to the slide layout element. The knowledge graph includes a hierarchy of a presentation template, its slides, and the slide's content elements (also referred to herein as “slide layout elements”). In some cases, the operations of this step refer to, or may be performed by, a presentation structuring component as described with reference to FIG. 2. The presentation structure is created by mapping the sections from the outline to slide objects (slide nodes in the knowledge graph), each including structured attributes such element containers and text and image elements. An example of a presentation structure is described with reference to FIG. 11.

At operation 1320, the system generates the final presentation based on the presentation outline. Each slide in the presentation corresponds to a slide object from the presentation structure and includes content elements that match the structured attributes defined during the previous steps. These content elements are either provided by the user or generated by the system, ensuring the slides are appropriately populated and aligned with the user's input. This operation may be performed by a presentation composer, as described with reference to FIG. 2, which assembles the final slides with text, visuals, and other components.

In some embodiments, the system obtains an input prompt describing a topic; generates, using a text generation model, a presentation outline based on the input prompt; generates a presentation structure based on the presentation outline, where the presentation structure includes a structured attribute indicating a slide layout element; and generates a presentation on the topic based on the presentation structure. The presentation comprises a slide including the slide layout element.

For example, the slide layout element could include an image element, a title element, or a list element. The outline describes content for various sections of slides, and the presentation structure is a structured object (e.g., a JSON structure) including multiple slide objects based on the outline. Each slide object includes one or more slide layout elements with content appropriate for the subject and corresponding to the layout described by the presentation structure.

FIG. 14 shows an example of a computing device 1400 according to aspects of the present disclosure. The example shown includes computing device 1400, processor(s) 1405, memory subsystem 1410, communication interface 1415, I/O interface 1420, user interface component(s), and channel 1430.

In some embodiments, computing device 1400 is an example of, or includes aspects of, a presentation generation apparatus as described in FIGS. 1 and 2. In some embodiments, computing device 1400 includes one or more processors 1405 are configured to execute instructions stored in memory subsystem 1410 to obtain an input prompt describing a topic; generate, using a text generation model, a presentation outline based on the input prompt; generate a presentation structure based on the presentation outline by traversing a knowledge graph comprising a slide archetype, wherein the slide archetype includes a slide layout element, and wherein the presentation structure includes a slide object including a structured attribute corresponding to the slide layout element; and generate a presentation based on the presentation outline, wherein the presentation comprises a slide corresponding to the slide object and including a content element corresponding to the structured attribute.

According to some aspects, computing device 1400 includes one or more processors 1405. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1410 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. The memory may store various parameters of machine learning models used in the components described with reference to FIG. 2. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1415 operates at a boundary between communicating entities (such as computing device 1400, one or more user devices, a cloud, and one or more databases) and channel 1430 and can record and process communications. In some cases, communication interface 1415 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1420 is controlled by an I/O controller to manage input and output signals for computing device 1400. In some cases, I/O interface 1420 manages peripherals not integrated into computing device 1400. In some cases, I/O interface 1420 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating systems. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1420 or via hardware components controlled by the I/O controller.

According to some aspects, user interface component(s) 1425 enable a user to interact with computing device 1400. In some cases, user interface component(s) 1425 include an audio device, such as an external speaker system, an external display device such as a display screen, an input device (e.g., a remote-control device interfaced with a user interface directly or through the I/O controller), or a combination thereof. In some cases, user interface component(s) 1425 include a GUI.

Accordingly, the present disclosure includes the following aspects.

A method for generation of slide presentations is described. One or more aspects of the method include obtaining an input prompt describing a topic; generating, using a text generation model, a presentation outline based on the input prompt; generating a presentation structure based on the presentation outline by traversing a knowledge graph comprising a slide archetype, wherein the slide archetype includes a slide layout element, and wherein the presentation structure includes a slide object including a structured attribute corresponding to the slide layout element; and generating a presentation based on the presentation outline, wherein the presentation comprises a slide corresponding to the slide object and including a content element corresponding to the structured attribute.

In some aspects, the presentation outline includes a plurality of sections, and wherein each of the plurality of sections includes at least one key point corresponding to the topic. In some aspects, the slide layout element comprises a title element, a text element, an image element, or any combination thereof. Some examples of the method, apparatus, non-transitory computer readable medium, and system further include obtaining a slide template. Some examples further include classifying the slide template to obtain the slide archetype. Some examples further include segmenting the slide template to obtain the slide layout element.

Some examples of the method, apparatus, non-transitory computer readable medium, and system further include obtaining a location of the slide layout element. In some aspects, the content element is generated using the text generation model. In some aspects, the content element is generated using an image generation model. Some examples of the method, apparatus, non-transitory computer readable medium, and system further include updating a value attribute of a node of the knowledge graph to include a value of the content element. Some examples of the method, apparatus, non-transitory computer readable medium, and system further include updating a location attribute of a node of the knowledge graph based on the value attribute of a parent node.

A system for generation of slide presentations is described. One or more aspects of the apparatus include obtaining an input prompt describing a topic; generating, using a text generation model, a presentation outline based on the input prompt; generating a presentation structure based on the presentation outline by traversing a knowledge graph comprising a slide archetype, wherein the slide archetype includes a slide layout element, and wherein the presentation structure includes a slide object including a structured attribute corresponding to the slide layout element; and performing a content fitting algorithm to generate a presentation based on the presentation outline, wherein the presentation comprises a slide corresponding to the slide object and including a content element corresponding to the structured attribute.

Some examples of the apparatus, system, and method further include segmenting a slide template to obtain a location of the slide layout element, wherein the content fitting algorithm is based on the location of the slide layout element. In some aspects, the location comprises a bounding box circumscribing content of the content element. Some examples of the apparatus, system, and method further include updating a value attribute of a node of the knowledge graph to include a value of the content element. Some examples of the apparatus, system, and method further include updating a location attribute of a node of the knowledge graph based on the value attribute of a parent node. In some aspects, the content element includes content generated by an image generation model.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the concepts described. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The methods described may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input prompt describing a topic;
generating, using a text generation model, a presentation outline based on the input prompt;
generating a presentation structure based on the presentation outline, wherein the presentation structure includes a structured attribute indicating a slide layout element; and
generating a presentation on the topic based on the presentation structure, wherein the presentation comprises a slide including the slide layout element.

2. The method of claim 1, wherein:
the presentation outline includes a plurality of sections and each of the plurality of sections includes at least one key point corresponding to the topic.

3. The method of claim 1, wherein:
the slide layout element comprises a title element, a text element, an image element, or any combination thereof.

4. The method of claim 1, further comprising:
obtaining a slide template; and
classifying the slide template to obtain a slide archetype, wherein the slide layout element is based on the slide archetype.

5. The method of claim 1, further comprising:
obtaining a slide template; and
segmenting the slide template to obtain the slide layout element.

6. The method of claim 1, wherein:
the presentation structure includes a plurality of slide objects, and wherein one of the plurality of slide objects includes the slide layout element.

7. The method of claim 1, wherein generating a presentation comprises:
generating the content element using the text generation model.

8. The method of claim 1, wherein generating a presentation comprises:
generating the content element using an image generation model.

9. The method of claim 1, wherein generating a presentation structure comprises:
traversing a knowledge graph comprising a slide archetype, wherein the slide archetype includes the slide layout element.

10. The method of claim 9, wherein traversing the knowledge graph comprises:
updating a value attribute or a location attribute of a node of the knowledge graph.

11. A non-transitory computer readable medium storing code for data processing, the code comprising instructions that, when executed by at least one processor, cause the at least one processor to perform operations comprising:
obtaining an input prompt;
generating, using a text generation model, a presentation outline based on the input prompt;
identifying a slide layout element based on a knowledge graph that includes the slide layout element; and
generating a presentation based on the slide layout element, wherein the presentation comprises a slide including a content element corresponding to the slide layout element.

12. The non-transitory computer readable medium of claim 11, wherein:
the presentation outline includes a plurality of sections and each of the plurality of sections includes at least one key point corresponding to the topic.

13. The non-transitory computer readable medium of claim 11, wherein:
the slide layout element comprises a title element, a text element, an image element, or any combination thereof.

14. The non-transitory computer readable medium of claim 11, the code further comprising instructions that, when executed by the at least one processor, cause the at least one processor to perform operations comprising:
obtaining a slide template; and
classifying the slide template to obtain a slide archetype with the slide layout element, wherein the knowledge graph includes the slide archetype.

15. A system comprising:
a memory component; and
a processing device coupled to the memory component, the processing device configured to perform operations comprising:
obtaining an input prompt describing a topic;
generating, using a text generation model, a presentation outline based on the input prompt;
generating a presentation structure based on the presentation outline, wherein the presentation structure includes a structured attribute indicating a slide layout element; and
generating a presentation on the topic based on the presentation structure, wherein the presentation comprises a slide including the slide layout element.

16. The system of claim 15, wherein generating the presentation on the topic comprises:
performing content fitting based on the presentation outline.

17. The system of claim 15, wherein the processing device is further configured to perform operations comprising:
segmenting a slide template to obtain a location of the slide layout element, wherein the content fitting is based on the location of the slide layout element.

18. The system of claim 15, wherein the processing device is further configured to perform operations comprising:
updating a value attribute of a knowledge graph to include a value of the slide layout element.

19. The system of claim 18, wherein the processing device is further configured to perform operations comprising:
updating a location attribute of a node of the knowledge graph based on the value attribute of a parent node.

20. The system of claim 15, wherein:
the slide layout element includes content generated by an image generation model.
